(19) United States
(12) Patent Application Publication
(10) Pub. No.: US 2002/0030857 A1
(43) Pub. Date: Mar. 14, 2002

(54) Scanning lens device of scanner

(76) Inventors: Chieh-Jen Lee, Taichung (TW); Yung-Jye Tzeng, Taichung (TW); Jung-Hong Chen, Yunlin Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/730,808

(22) Filed: Dec. 7, 2000

(30) Foreign Application Priority Data
Jun. 15, 2000 (TW) 89210223

(51) Int. Cl. H04N 1/40

(52) U.S. Cl. 358/471

(57) ABSTRACT

An optical scanner has a scanning lens device comprising a lens module and at least two lenses mounted on the lens module to scan an object separately such that the object is divided into two scanning areas. The image data of the two scanning areas are integrated to form a complete image of the object.

### FIELD OF THE INVENTION

The present invention relates generally to an optical scanner, and more particularly to a scanning lens device of the optical scanner that can scan object with a short distance.

### BACKGROUND OF THE INVENTION

As shown in FIGS. 1 and 2, a lens module 81 of a prior art scanner 80 is provided with a lens 82. The formation of the object image distance by the lens 82 is attained by means of a plurality of reflectors 85 in view of the fact that the image of an object 83 is formed via the lens 82 on CCD (charged couple device) 84. In order to enhance the resolution, the conventional scanning lens is formed of even more than four to six lenses, which result in an increase in the volume of the lens module 81. In addition, the object image distance is a factor determining the number of the reflectors 85, as shown in FIGS. 3 and 4. For example, a scanning lens comprising 6 lenses has a length of 24.5 mm. Under the condition of a constant MTF, the reasonable scanning angle is less than 45 degrees to keep good performance while the object image distance is 301 mm. As a result, more reflectors are needed. The structure of the lens module 81 is thus complicated. The cost of making the lens module 81 is substantially increased.

### SUMMARY OF THE INVENTION

The primary objective of the present invention is to provide an optical scanner with a lens device that can shorten object image distance and reduce the numbers of the reflectors in order to simplify the construction of the lens module.

The further objective of the present invention is to provide an optical scanner with a lens device that is designed easy and is simple in construction of the scanning lens and cost-effective.

The lens device of the present invention comprises a lens module and at least two lenses mounted on the lens module such that the image data of the divided scanning areas of an object are integrated to form a complete image of the object.

The prior art scanner having longer object image distance than the present invention needs more reflectors, so the volume of the lens is also increased. In addition, the cost of making lens module is substantially increased, and the structure of the lens module is thus complicated.

Because the present invention using two lenses at least requires short object image distance as compared with the prior art using one lens, the present invention only needs fewer reflectors. MIT of the present invention is as good as the prior art although both the prior art and the example of the present invention use 6 lenses. Meanwhile, the present invention can be designed easy, simplified the construction of the lens module and cost-effective.

### BRIEF DESCRIPTION OF THE DRAWINGS

FIG. 1 shows a schematic view of the internal structure of a scanner of the prior art.

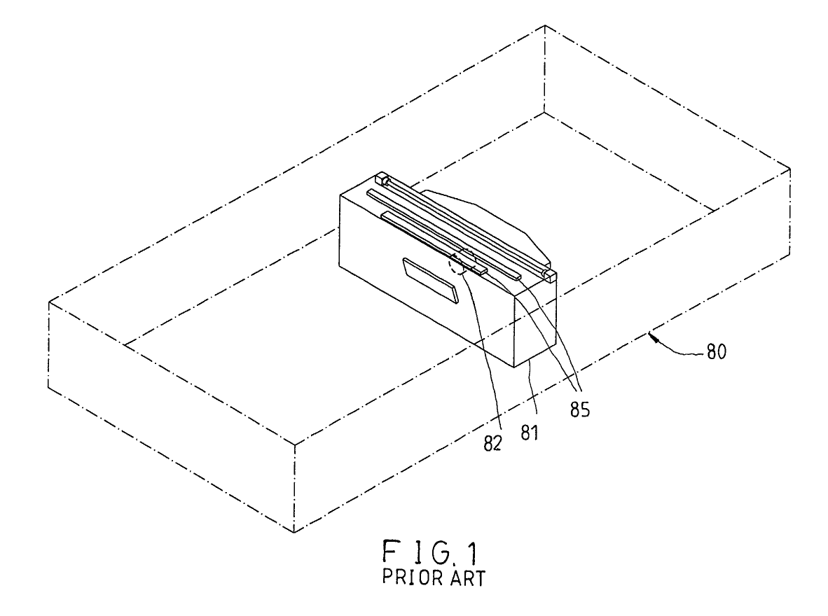

FIG. 2 shows a schematic view of the image-forming optical path of the prior art scanner.

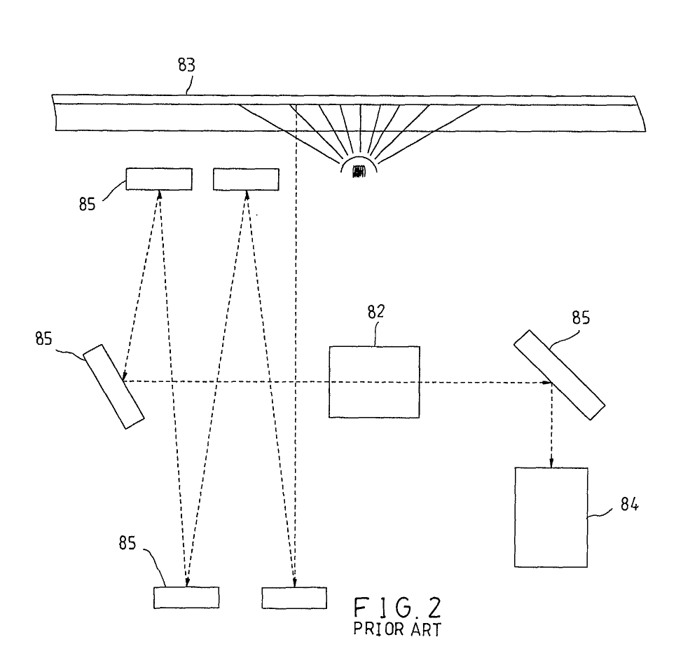

FIG. 3 shows a schematic view of distance relationship between the lens and the object during scanning and image-forming of the prior art scanner.

FIG. 4 shows relevant data of scanning an object by the prior art scanner.

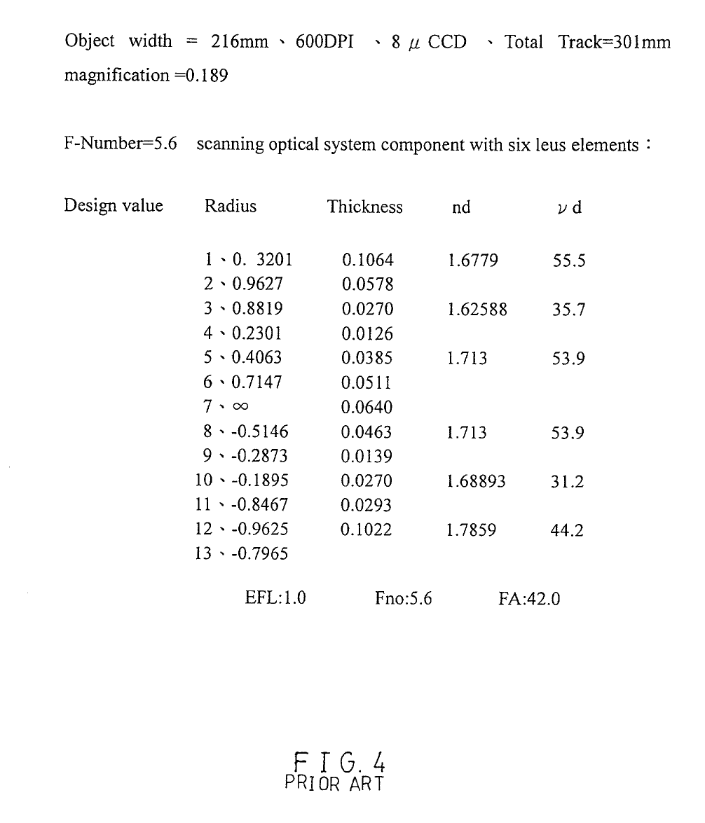

FIG. 5 shows a perspective view of the present invention.

FIG. 6 shows a space relationship between the lens and the object during scanning and image-forming of the present invention.

FIG. 7 shows relevant data of scanning an object by the present invention.

FIG. 8 shows space relationship between the lens and the object during scanning and image-forming of the prior art and the present invention.

FIG. 9 shows comparison of scanning data of the present invention and the prior art under the conditions of 1200 DPI resolution and different object image distances.

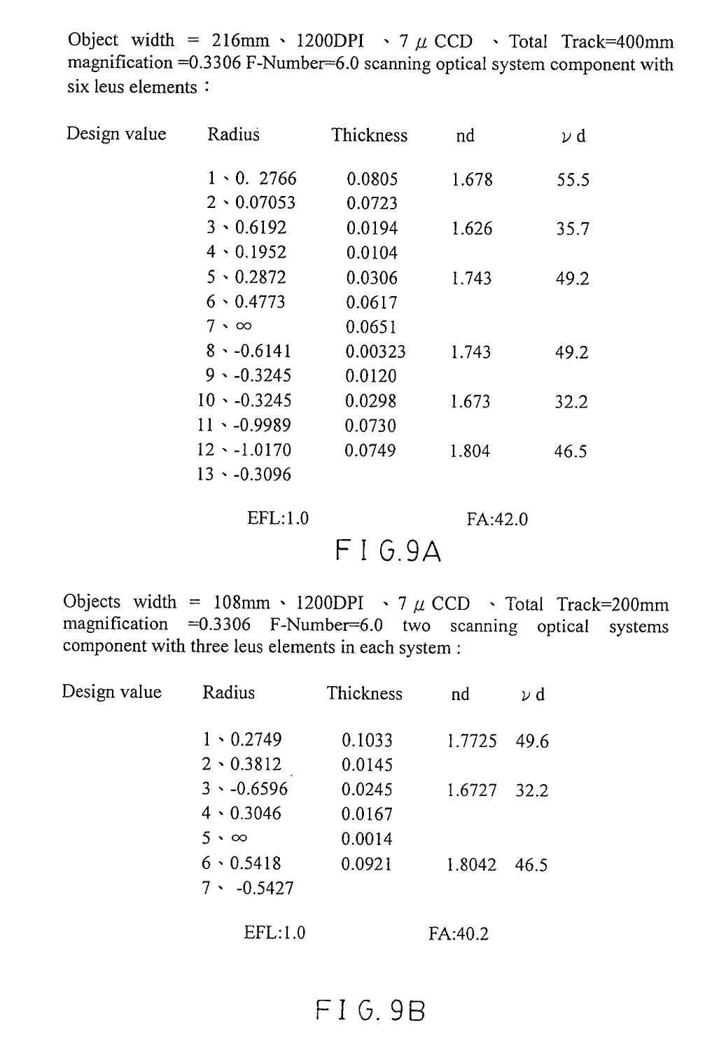

FIG. 10 shows the MTF of the present invention under the condition of 600 DPI resolution.

FIG. 11 shows the MTF of the prior art under the condition of 600 DPI resolution.

FIG. 12 shows the MTF of the present invention under the condition of 1200 DPI resolution.

FIG. 13 shows the MTF of the prior art under the condition of 1200 DPI resolution.

### DETAILED DESCRIPTION OF THE INVENTION

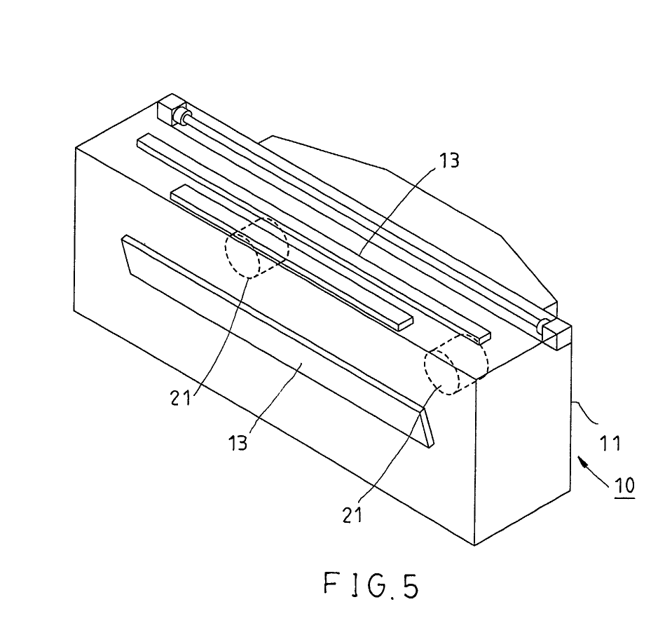

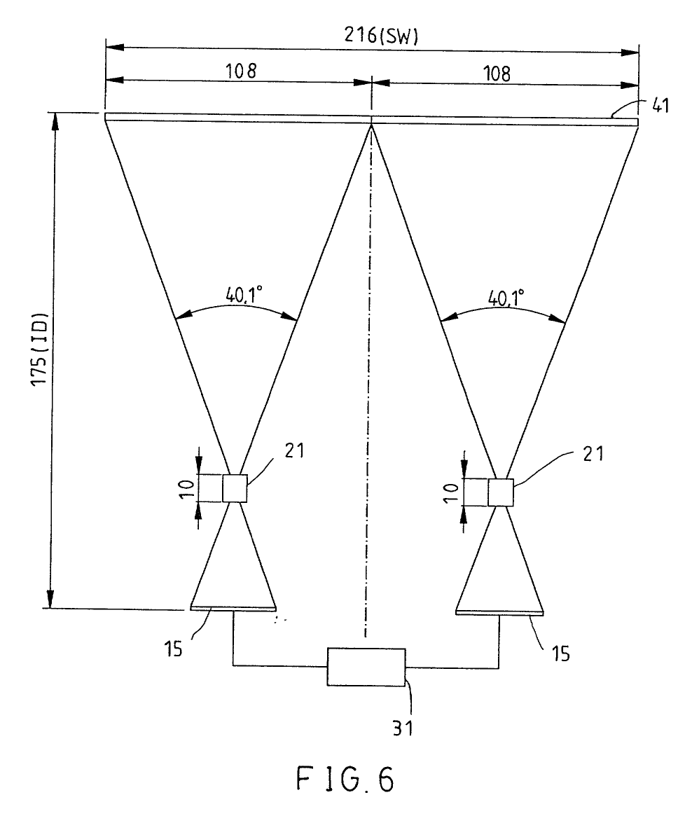

As shown in FIGS. 5 and 6, a scanner lens device 10 of the present invention comprises a lens module 11, and two lenses 21 mounted on the lens module 11.

The lens module 11 is provided with several reflectors 13.

The two same lenses 21 are horizontally mounted on the lens module 11 such that both lenses 21 are equal in an object image distance Id to each other in relation to an object 41 to be scanned, and that the scanning object widths SW of the lenses 21 are equal and are partially overlapped. In the course of scanning, the object 41 is divided into two portions by the two lenses 21. The image-forming portion of the lens module 11 is provided with a CCD 15 for converting the image into a potential signal.

An image processor 31 is mounted on the lens module 11 or in the scanner and is connected with the CCD 15 for integrating the potential signals of the CCD 15 such that the signal overlapping portions are compared and then cross-collected to form a complete image. The technique of the image processor is a prior art.

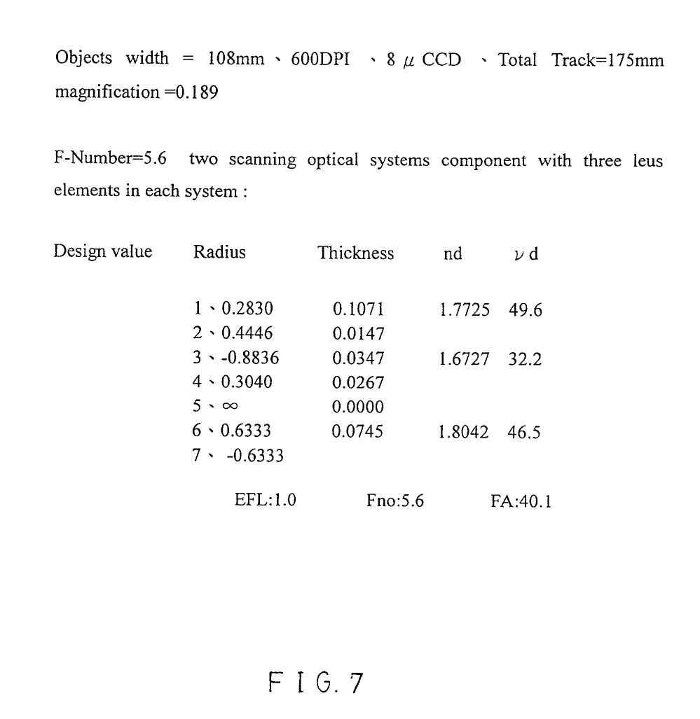

As shown in FIGS. 5-7, An example of the present invention is formed of three lens elements for scanning an object 41 with an object width of 216 mm. The object 41 is divided by two lenses 21 into two portions that are partially overlapped. The scanning width SW is about the half of the object width (wider than 108 mm) for each lens 21 so the object 41 can be scanned completely. The image data of the two lenses 21 are integrated by the processor 31 and formed a same image as object 41.

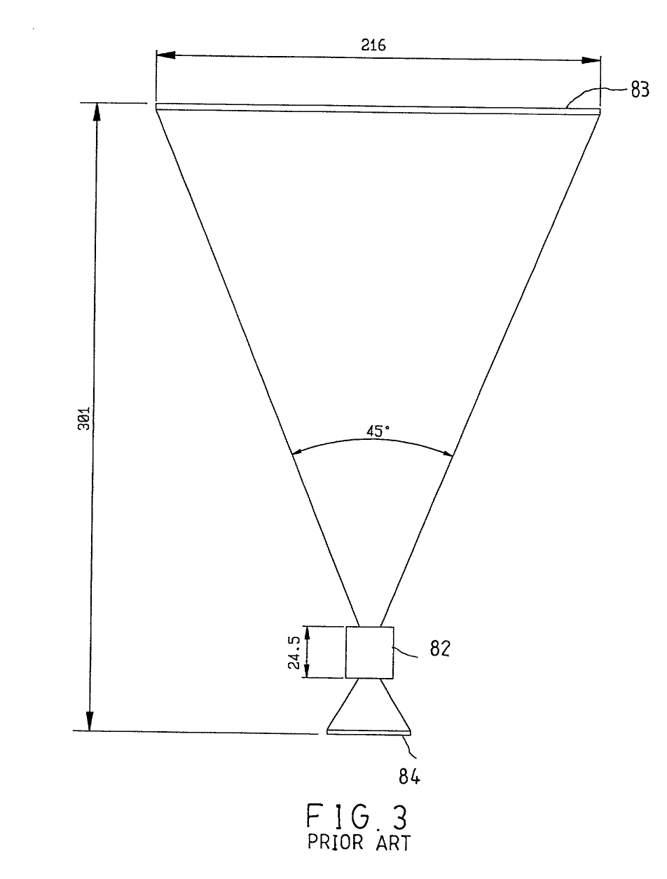

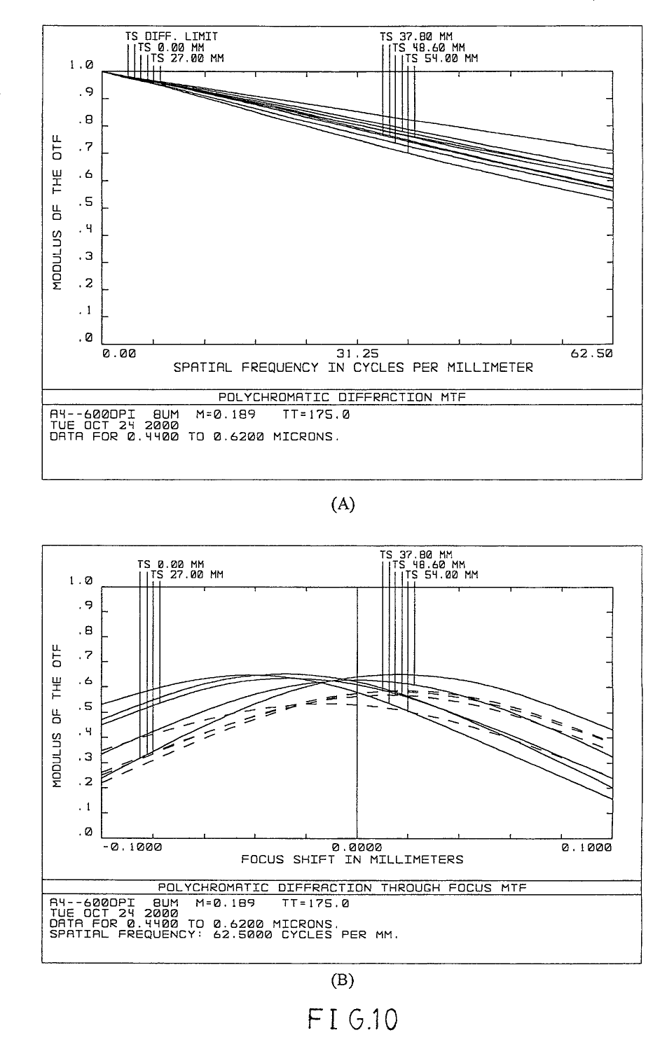

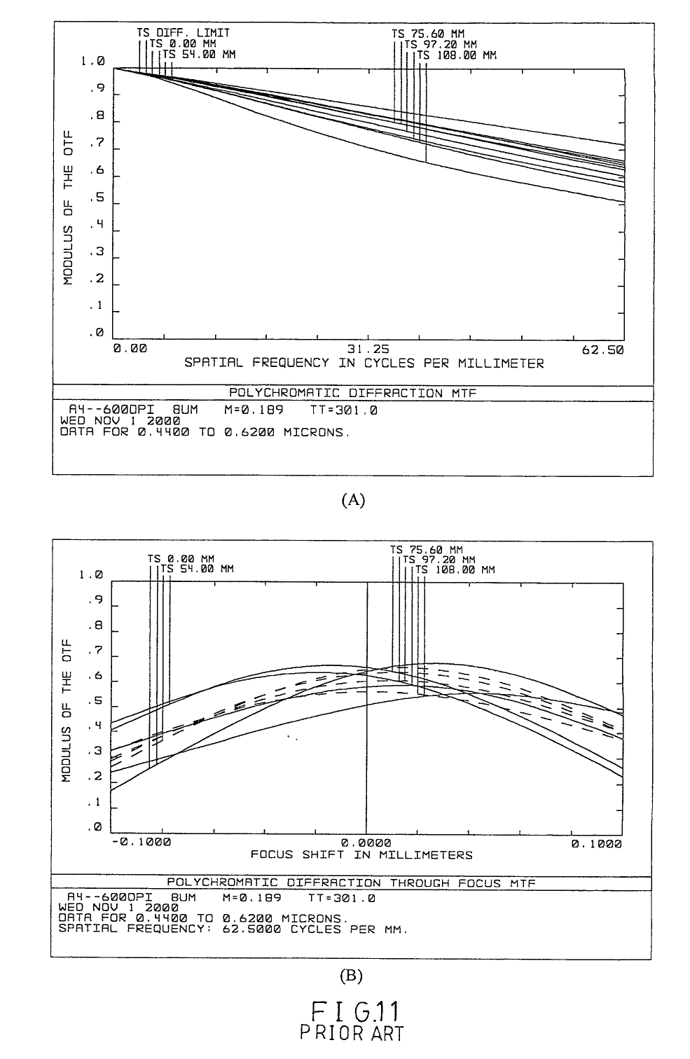

As shown in FIGS. 3 and 6, the present invention is relatively simple in construction as compared with the prior art. The prior art used 6 lenses. The lens length of the present invention is 10 mm as compared with 24.5 mm of the prior art. The object image distance of the present invention is 175 mm as compared with 301 mm of the prior art. MTF of the present invention as shown in FIG. 10 is equal to that of the prior art as shown in FIG. 11. The present invention is designed easy and simple in the construction of the lens.

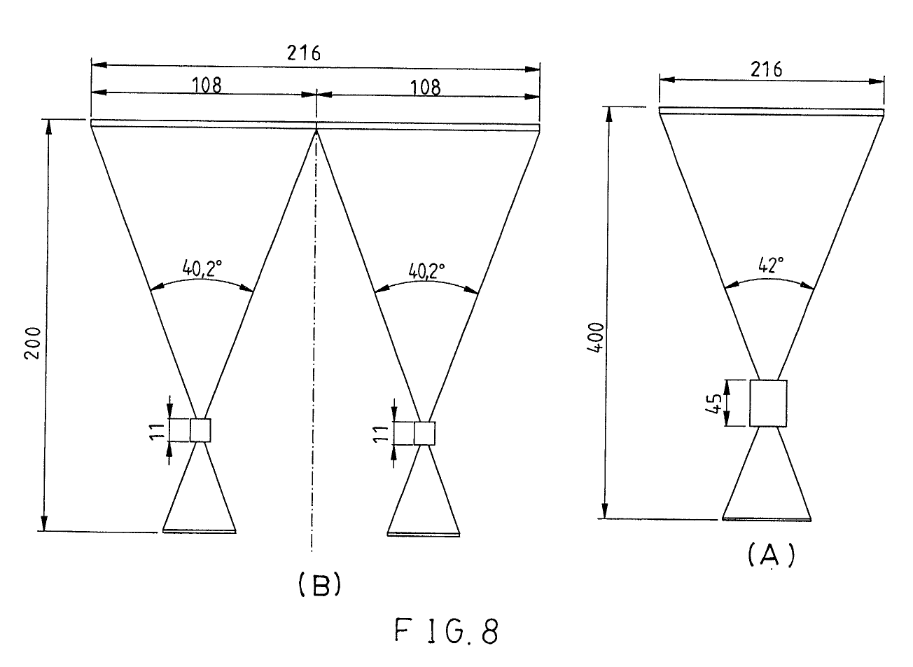

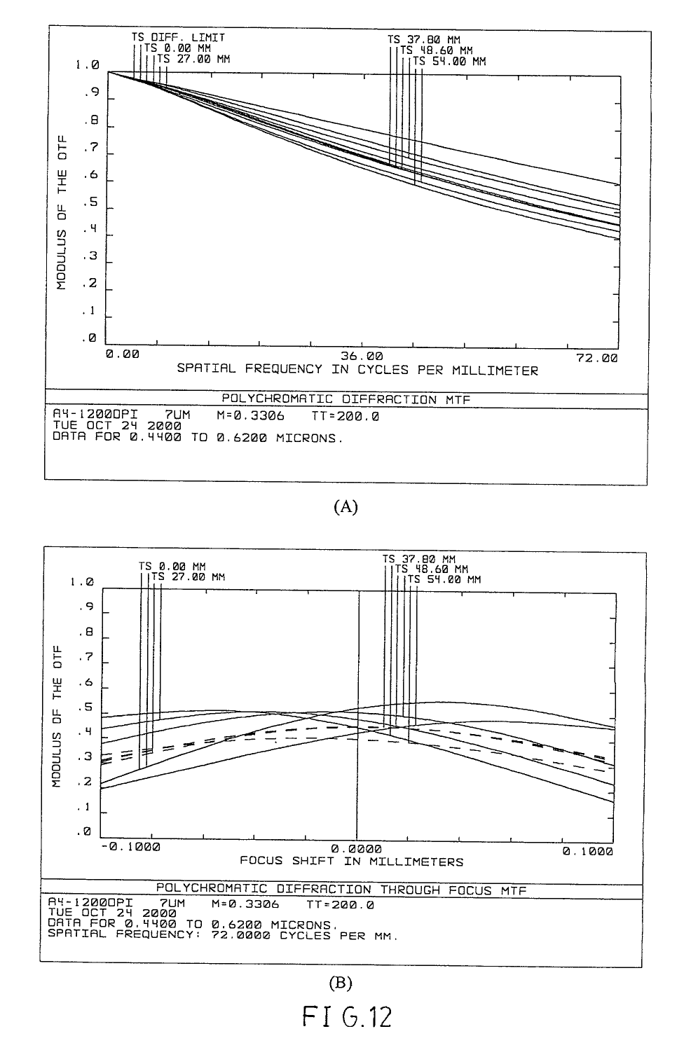

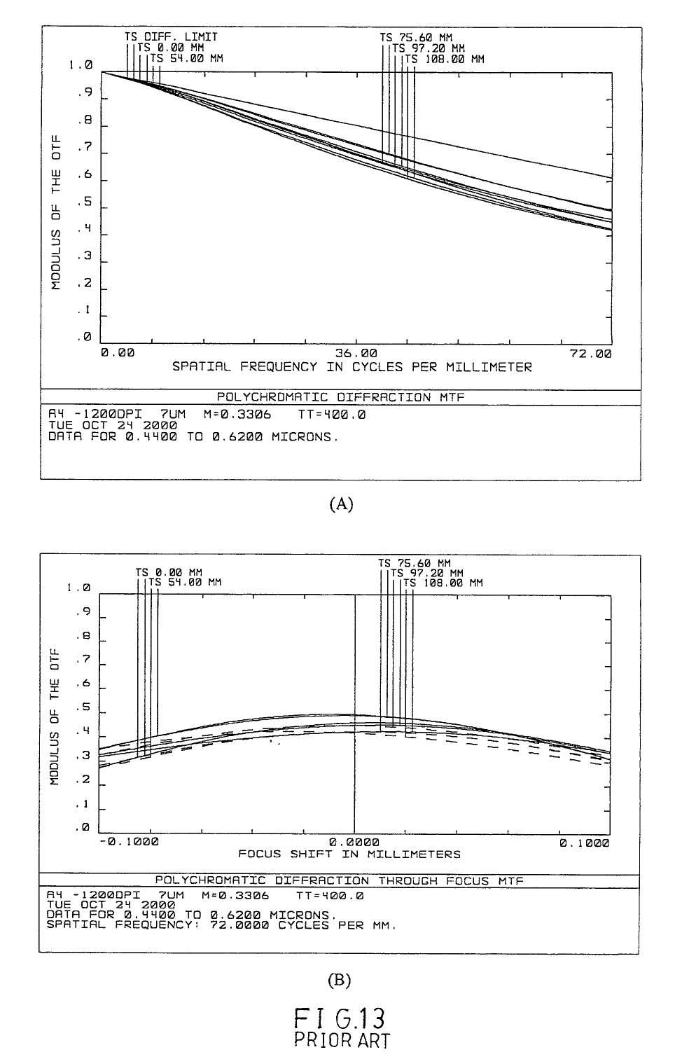

As shown in FIG. 8, under the condition of the 1200 DPI resolution, the object image distance of the present invention is 200 mm as compared with 400 mm of the prior art. MTF of the present invention showing in FIG. 12 is as good as that of the prior art showing in FIG. 13.

In light of the above data, it is readily apparent that the present invention requires fewer lenses as compared with the prior art, and that the design of the lens device of the present invention can be simplified and cost-effective. In addition, the present invention is adapted to various conditions of 600 DPI, 1200 DPI, and 2400 DPI resolutions.

The lens module of the present invention may be provided with three or more lenses to carry out the scanning simultaneously in such a manner that the synthesis of one image is brought about by the image overlapping, thereby resulting in a decrease in the object image distance and a miniaturization of the lens module.

What is claimed is:

1. A scanning lens device of a scanner, said device comprising:
a lens module; and two or more lenses mounted on said lens module whereby said lenses scan an object separately such that the object is divided into two scanning areas.

2. The scanning lens device as defined in claim 1, wherein said lens is provided with CCD equal in number to said lenses whereby said CCD converts an image signal of each of said lenses into a potential signal, said lens module further provided with an image processor for integrating the potential signals transmitted from said CCD in order to form an image signal as object.

3. The scanning lens device as defined in claim 1, wherein said scanning areas are partially overlapped.

4. The scanning lens device as defined in claim 1, wherein said two lenses are equal to each other in terms of scanning distance relative to the object.

5. The scanning lens device as defined in claim 1, wherein said two scanning areas of each lens are equal in width to each other.
